(19) United States
(12) Patent Application Publication
(10) Pub. No.: US 2024/0292852 A1
(43) Pub. Date: Sep. 5, 2024

(54) DAIRY CREAMER WITH A LOW CARBOHYDRATE CONTENT

(71) Applicant: WHITEWAVE SERVICES, INC., BROOMFIELD, CO (US)

(72) Inventors: Pulari KRISHNANKUTTY NAIR, Erie, CO (US); Duc NGUYEN, Erie, CO (US)

(73) Assignee: WHITEWAVE SERVICES, INC., BROOMFIELD, CO (US)

(21) Appl. No.: 18/270,006

(22) PCT Filed: Dec. 29, 2021
(86) PCT No.: PCT/US2021/065475

§ 371 Date: Jun. 28, 2023

Related U.S. Application Data
(60) Provisional application No. 63/131,662, filed on Dec. 29, 2020.

(51) Int. Cl. A23C 9/142; A23C 9/15; B01D 61/14

(52) U.S. Cl. CPC A23C 9/1422; A23C 9/1516; B01D 61/146; B01D 2311/08

(57) ABSTRACT

The present disclosure relates to a process for producing a dairy creamer and to a dairy creamer obtainable by such a process. The dairy creamer has a fat content not lower than 10.5 wt % and a carbohydrate content equal to or lower than 3.3 wt %. A skim milk having a protein content ranging from 2.5 to 4.5 wt % and a carbohydrate content ranging from 4.5 to 5.5 wt % is used as the starting material in the disclosed process.

### FIELD OF THE INVENTION

The invention relates to a new method for manufacturing a dairy creamer, in particular half-and-half creamer, that has a low carbohydrate content, in particular a dairy creamer that is lactose-free and optionally carbohydrate-free.

### BACKGROUND OF THE INVENTION

Dairy creamers are largely consumed in the United States. Dairy creamers are typically used to whiten beverages, in particular coffee, thereby producing smoother and milder drinks. Most popular dairy creamers are “half-and-half” creamers. Half-and-half creamers are fluid dairy products that have a fat content not lower than 10.5 wt %. They taste similar to milk but are creamier. They allow preparing creamy beverages but not as thick and rich than beverages prepared with heavy cream or whipped cream. They can also be incorporated in recipes. Half-and-half creamers are typically prepared by blending equal parts of milk and cream.

Half-and-half creamers have some nutritional shortcomings. They are rich in fat and contain high amounts of carbohydrate (typically about 4.5-5.5 wt % of carbohydrate originating from the milk).

In order to enhance their nutritional and health values, fat-free half-and-half creamers have been proposed. Fat-free half-and-half creamers are typically prepared by combining skim milk with corn syrup instead of cream, resulting in a fat-free product that is higher in added sugar. Lactose-free half-and-half creamers have also been proposed. However, lactose-free half-and-half creamers still contain sugar (not less than 1 g per serving (about 15 mL)). Typically, lactose-free half-and-half creamers are prepared using lactase that hydrolyzes lactose in glucose and galactose. There are no further removal methods employed for these carbohydrates and they remain in the product.

Consumers being more and more concerned by health and nutritional aspects, there is an increasing demand for products with reduced carbohydrate content or no carbohydrate at all. Therefore, there is still a need for half-and-half creamers having a low carbohydrate content, in particular half-and-half creamers having a negligible total carbohydrate content as compared to lactose-free half-and-half creamers, and which maintain the organoleptic properties of regular half-and-half creamers.

### SUMMARY OF THE INVENTION

The invention relates to a process for producing a dairy creamer that has a fat content not lower than 10.5% by weight and a carbohydrate content equal to or lower than 3.3 wt %, comprising the steps of:
a) providing a volume of skim milk having a protein content ranging from 2.5 to 4.5 wt % and a carbohydrate content ranging from 4.5 to 5.5 wt %;
b) concentrating the skim milk by ultrafiltration and collecting the obtained protein-enriched retentate;
c) diluting the protein-enriched retentate with enough water to reach at least 80 vol % of the initial volume of skim milk to obtain a diluted fraction having a reduced carbohydrate content;
d) optionally repeating one or more times steps b) and c) on the diluted fraction resulting from step c) to further reduce the carbohydrate content of the diluted fraction;
e) concentrating the diluted fraction resulting from step c) or d) by ultrafiltration and collecting the obtained protein-enriched retentate;
f) diluting the protein-enriched retentate resulting from step e) with enough water to provide a diluted fraction having a protein content ranging from 2.5 to 4.5 wt %;
g) adding cream to the diluted fraction resulting from step f) to provide a dairy creamer that has a fat content not lower than 10.5% by weight;
h) optionally adding a stabilizing salt and/or a flavor to the dairy creamer;
i) heat treating the dairy creamer;
j) optionally homogenizing the dairy creamer; and
k) packaging the dairy creamer.

The present invention relates also to a dairy creamer that has a fat content not lower than 10.5 wt % and a carbohydrate content equal to or lower than 3.3 wt %, preferably equal to or lower than 0.10 wt %, obtainable by a process according to the present invention.

Further aspects of the invention are as disclosed herein and in the claims.

### Definitions

The term “about” or “approximately” means in the context of the present invention that the concerned value may be lower or higher by 10%, especially by 5%, in particular by 1%, than the indicated value. It encompasses the indicated value and values that may be lower or higher by 10%, especially by 5%, in particular by 1%, than the indicated value. As a matter of examples, when a range is said to vary from about X to about Y, it includes the range from X to Y and optionally values that may be lower by 10%, especially by 5%, in particular by 1%, than X and values that may be higher by 10%, especially by 5%, in particular by 1% than Y.

Percentage by weight, percentage by mole and percentage by volume are respectively abbreviated herein as wt %, mol % and vol %.

### DESCRIPTION OF THE INVENTION

The present invention relates to a process for producing a dairy creamer that has a fat content not lower than 10.5% by weight and a carbohydrate content equal to or lower than 3.3 wt %, comprising the steps of:
a) providing a volume of skim milk having a protein content ranging from 2.5 to 4.5 wt % and a carbohydrate content ranging from 4.5 to 5.5 wt %;
b) concentrating the skim milk by ultrafiltration and collecting the obtained protein-enriched retentate;
c) diluting the protein-enriched retentate with enough water to reach at least 80 vol % of the initial volume of skim milk to obtain a diluted fraction having a reduced carbohydrate content; 20)
d) optionally repeating one or more times steps b) and c) on the diluted fraction resulting from step c) to further reduce the carbohydrate content of the diluted fraction;
e) concentrating the diluted fraction resulting from step c) or d) by ultrafiltration and collecting the obtained protein-enriched retentate;
f) diluting the protein-enriched retentate resulting from step e) with enough water to provide a diluted fraction having a protein content ranging from 2.5 to 4.5 wt %;
g) adding cream to the diluted fraction resulting from step f) to provide a dairy creamer that has a fat content not lower than 10.5% by weight;
h) optionally adding a stabilizing salt and/or a flavor to the dairy creamer;
i) heat treating the dairy creamer;
j) optionally homogenizing the dairy creamer; and
k) packaging the dairy creamer.

The dairy creamer that has a fat content not lower than 10.5% by weight is referred herein after as “half-and-half creamer”. Generally, the half-and-half creamer has a fat content ranging from 10.5 wt % to 18 wt %.

The term “carbohydrate” designates saccharides (monosaccharides, disaccharides, oligosaccharides and polysaccharides). Milk saccharides encompasses predominately lactose with trace amounts of monosaccharides and oligosaccharides.

The half-and-half creamer obtained by the process of the present invention has a reduced carbohydrates content. The half-and-half creamer comprises less than 4.5 wt % of carbohydrates, in particular 3.3 wt % or less, notably 3.0 wt % or less, 2.0 wt % or less, 1.0 wt % or less, or even 0.5 wt % or less of carbohydrates.

In some embodiments, the half-and-half creamer is a lactose free half-and-half creamer. By “lactose-free” as used herein, it is meant that the lactose content is comprised between 0 and 0.5 wt %. This corresponds to a lactose content comprised between 0 and 0.075 g per serving (about 15 mL).

In some embodiments, the half-and-half creamer is a carbohydrate free half-and-half creamer. By “carbohydrate-free” as used herein, it is meant that the carbohydrate content is comprised between 0 and 0.5 wt %. This corresponds to a carbohydrate content comprised between 0 and 0.075 g per serving (about 15 mL).

The half-and-half creamer obtained by the process of the present invention may comprise from 0 wt % to 3.3 wt %, notably from 0 wt % to 3.0 wt % of carbohydrates, such as from 0 wt % to 2.0 wt % of carbohydrates, in particular from 0 wt % to 1.0 wt % of carbohydrates, preferably from 0 wt % to 0.5 wt % of carbohydrates, and even more preferably from 0.1 to 0.5 wt % of carbohydrates.

The half-and-half creamer obtained by the process of the present invention may comprise from 0 wt % to 0.45 wt % of carbohydrates per serving, notably from 0 wt % to 0.30 wt % of carbohydrates per serving, in particular from 0 wt % to 0.15 wt % of carbohydrates per serving, preferably from 0 wt % to 0.075 wt % of carbohydrates per serving, and even more preferably from 0.015 wt % to 0.075 wt % of carbohydrates per serving. The half-and-half creamer obtained by the process of the present invention may comprise 0 grams of carbohydrates per serving. The serving size may be about 15 mL.

The half-and-half creamers obtained by the process of the present invention meet the standard of identity required to be called “half-and-half creamer”. They maintain the organoleptic properties of regular half-and-half creamers. They have the appearance, taste, body, mouth feel and whitening ability of a regular half-and half creamer while having a negligible total sugar content as compared to lactose-free half-and-half creamer. Advantageously, they may be suitably included in the diet of persons for whom a reduced intake of sugar or calories is necessary or desirable.

### Step a)

Any skim milk (or skimmed milk) can be used in the present process. Preferably, the skim milk originates from any lactating livestock animal whose milk is suitable for human consumption (e.g., cows, goats, sheep). Typically, skim milk originates from cow's milk. Although many factors may affect the composition of raw cow's milk, it generally contains from about 8.5 to about 15 wt % of total solids, from about 2 to about 6 wt % of fat, from about 2.5 to about 5 wt % of proteins (total protein content), from about 4.5 to about 5.5 wt % of carbohydrates (mainly lactose), from about 0.5 to about 1 wt % of minerals, and from about 85 to about 89 wt % of water.

Skim milk may be prepared by any conventional methods known to remove fat from milk. The use of separator in dairy plants permits fractionation of whole milk into skim milk/low fat milk and cream. For example, centrifugal separator can be used.

Typically skim milk contains less than about 2.00 wt % fat, more particularly less than 1.00 wt % fat, and more particularly less than 0.50 wt % fat, and even more particularly less than 0.05 wt %.

Generally, skim milk contains from 8.5 to about 12.5 wt % of total solids.

Generally, skim milk contains from about 0 to about 1.0 wt % of fat, such as from about 0.01 to about 0.10 wt % of fat, notably from about 0.01 to about 0.05 wt % of fat.

Generally, skim milk contains from about 2.5 to about 4.5 wt % of proteins, such as from about 3.0 to about 4.0 wt % of proteins.

Generally, skim milk contains from about 4.5 to about 5.5 wt % of carbohydrates, such as from about 4.5 to about 5.0 wt % of carbohydrates (mainly lactose).

Generally, skim milk contains from about 0.6 to about 0.9 wt % of minerals.

Generally, skim milk contains from about 3.0 to about 4.0 wt % of proteins, from about 0.01 to about 0.1 wt % of fat and from about 4.5 to about 5.0 wt % of carbohydrates (mainly lactose).

The “fat content” of a product corresponds to the weight of the fat components present in the product relatively to the total weight of the product. The fat content is expressed as a weight percentage.

The fat content can be measured by the Weibull-Berntrop gravimetric method.

The “total solids content” of a product corresponds to the dry matter, i.e. the weight of non-volatile components present in the product relatively to the total weight of the product. The total solids content is expressed as a weight percentage. The “non-volatile components” correspond to the solids that remain after an evaporation step of the product at 103-105° C., notably 102° C. Typically “total solids” designates fat and solid-not-fat. “Solid-not-fat” generally refers to the proteins, carbohydrates (mainly lactose), minerals and vitamins.

The “proteins content” of a product corresponds to the weight of the proteins present in the product relatively to the total weight of the product. The total protein content is expressed as a weight percentage.

The proteins content can be measured by Kjeldahl analysis as the reference method for the determination of the total protein content of dairy products based on measurement of total nitrogen content. The method is described in both AOAC Method 991.20 (1) and international Dairy Federation Standard (IDF) 20B:1993.

The “carbohydrates content” of a product corresponds to the weight of the carbohydrates present in the product relatively to the total weight of the product. The carbohydrate content is expressed as a weight percentage.

The carbohydrates content can be measured by AOAC 930.28 or IDF 198 by a High Pressure Liquid Chromatography (HPLC).

The “minerals content” of a product corresponds to the weight of the minerals present in the product relatively to the total weight of the product. The minerals content is expressed as a weight percentage.

### Step b)

The skim milk is concentrated using ultrafiltration. Ultrafiltration is a well-known process in the dairy industry. Typically, ultrafiltration is used for concentration of milk proteins in milk. Ultrafiltration is typically used for efficiently separating the milk components, e.g. proteins, carbohydrates (mainly lactose), minerals, into different fractions. The membrane technologies are categorized by their molecular weight cut-off, supposedly the molecular weight of the smallest molecule that will not pass through the membrane. However, owing to various interactions, a membrane cannot be selected purely on the basis of molecular weight cut-off. The ultrafiltration is performed using membranes with adequate cut-off values that allow the proteins to remain in the retentate while carbohydrates (lactose) and minerals are allowed to pass with water into the permeate. The ultrafiltration covers a range of membrane pore sizes, i.e. cut-off value. The cut-off value generally varies from 0.002 to 0.05 μm or from 1,000 to 200,000 Molecular Weight (MW). Examples of suitable membranes include but are not limited to polymers and ceramics. In membrane filtration, the use of the pressures is essential as driving force for separation. Typically, the applied pressure during ultrafiltration is from 1 to 10 bar.

The concentration step is typically performed under pressure that ranges from 0.5 to 10 bar, preferably from 1 to 10 bar.

The concentration step is typically carried out at a temperature of at least 30° C., preferably at a temperature ranging from 30 to 55° C., such as from 35 to 55° C., typically at about 50° C.

A concentration factor ranging from 1.5 to 8 is typically achieved. The concentration factor can be in particular from 2 to 6, preferably from 2 to 4, such as from 2 to 3. The concentration factor is the volume reduction achieved by concentration, i.e. the ratio of initial volume of the solution to be concentrated or fractionated (skim milk) to the final volume of concentrate (retentate).

After concentration, the protein-enriched retentate is collected. The retentate is the concentrate, the retained liquid. The protein-enriched retentate is depleted from a substantial part of the lactose initially present in the skim milk and which is present in the permeate or the filtrate, the liquid passing through the membrane. Advantageously, the ultrafiltration allows reducing the lactose content of the dairy product without increasing its glucose and galactose content. Increase in glucose and galactose content is typically obtained when lactose is enzymatically hydrolyzed to provide low lactose or lactose-free dairy product. An example of enzyme called lactase split molecules of lactose into glucose and galactose.

Preferably, the process according to the invention does not use lactase.

Typically, the protein-enriched retentate obtained after concentrating the skim milk by ultrafiltration contains from 10 to about 25 wt % of total solids.

Typically, the protein-enriched retentate obtained after concentrating the skim milk by ultrafiltration contains from about 3.3 to about 20 wt % of proteins.

### Step c)

The collected protein-enriched retentate is then diluted by adding enough water to reach at least 80 vol % of the initial volume of skim milk which has been subjected to the ultrafiltration.

In some embodiments, water is added to reach 0.8 to 1.2, such as 0.9 to 1.2, in particular 1.0 to 1.2, such as 1.0 to 1.1, times the initial volume of skim milk which has been subjected to the ultrafiltration.

Water is preferably filtered potable water. Typically, the collected protein-enriched retentate is diluted by a factor ranging from 1 to 10 times. This allows obtaining a diluted fraction having a reduced carbohydrate content.

The carbohydrate content generally ranges from 0.1 to 4.3 wt %.

In another embodiment, step c) is done simultaneously with step b). Typically, this embodiment comprises a modification of ultrafiltration in which water is added to the skim milk as filtration proceeds in order to wash out skim milk components which will pass through the membranes, basically lactose and minerals. Such a method is called diafiltration.

### Optional Step d)

Depending on target carbohydrates values of the half-and-half creamer (low lactose or lactose-free half-and-half creamer), the carbohydrates content of the diluted fraction may be further reduced by repeating one or more times the concentration and dilution steps disclosed herein above (steps b) and c)).

In some embodiments, the concentration and dilution steps are repeated until obtaining a lactose-free diluted fraction. “Lactose-free diluted fraction” as used herein means that the diluted fraction contains less than 0.5 wt % lactose, i.e. from 0 to 0.5 wt % lactose. Typically, steps b) and c) are repeated 2, 3, 4, 5 or 6 times.

### Steps e) and f)

The diluted fraction obtained after one or several iterations of a concentration step (step b)) followed by a dilution step (step c)) is then one more time concentrated by ultrafiltration.

The ultrafiltration may be performed as disclosed herein in connection with step b).

The resultant protein-enriched retentate is collected and further diluted with enough water to provide a diluted fraction having a protein content ranging from 2.5 to 4.5 wt %. Typically, enough water (e.g. filterable potable water) is added to provide a diluted fraction having approximately the protein content of the starting milk, i.e. of the skim milk submitted to the process.

The obtained diluted fraction has a reduced carbohydrate content vs. the carbohydrate content of the skim milk submitted to the process. Typically, the carbohydrate content ranges from 0 to 3.0 wt %, such as from 0 wt % to 2.0 wt %, in particular from 0 wt % to 1.0 wt %, preferably from 0 wt % to 0.5 wt %, and even more preferably from 0.1 to 0.5 wt % (mainly lactose). In some embodiments, the diluted fraction is a lactose-free diluted fraction as defined herein above.

The obtained diluted fraction typically contains from about 5 to about 15 wt % of total solids, notably from about 7 to about 12 wt % of total solids.

The obtained diluted fraction typically contains from about 0 to about 2.0 wt % of fat, notably from about 0 to about 1.0 wt % of fat, such as from about 0.01 to about 0.10 wt % of fat, notably from about 0.01 to about 0.05 wt % of fat.

The obtained diluted fraction typically contains from about 0 to about 0.7 wt % of minerals.

### Step g)

Then, cream is added to the diluted fraction to provide a dairy creamer that has a fat content not lower than 10.5% by weight, in particular a fat content between 10.5% and 18% by weight. The purpose of the step g) is to give the diluted fraction a defined guaranteed fat content (typically between 10.5% and 18% by weight). “Cream” as used herein refers to the fat-rich fraction skimmed from whole milk, also known as “sweet cream”. Typically, the cream contains from about 11 wt % to about 80 wt % of fat, in particular at least 30 wt % fat, notably between 30 and 80 wt % fat, and more particularly between about 30 and about 40 wt % fat.

More or less cream may be added depending on the target fat values of the dairy creamer. Typically, from about 20 wt % to 40 wt % of cream is added to the diluted fraction with respect to the final dairy creamer. The addition of cream to the diluted fraction provides the creaminess, smoothness, thickness, viscosity and proper mouth feel expected for a dairy creamer.

The dairy creamer has a low carbohydrate content, i.e. equal to or lower than 3.3 wt %, typically equal to or lower than 3.0 wt %, notably equal to or lower than 2.0 wt %, for example equal to or lower than 1.0 wt %, preferably ranging from 0.1 to 0.5 wt %. In some embodiments, the dairy creamer is a carbohydrate-free dairy creamer, i.e. its carbohydrate content ranges from 0 wt % to 0.5 wt %. Typically, the dairy creamer is a lactose-free dairy creamer, i.e. its lactose content ranges from 0 wt % to 0.5 wt %.

The obtained dairy creamer typically has a fat content equal or higher than 10.5 wt %, preferably ranging from 10.5 to 18 wt %.

The obtained dairy creamer typically contains from about 2.5 to about 4.5 wt % of proteins, in particular from about 3.0 to about 4.5 wt %.

The ratio of fat to proteins typically falls in the range of typical half and half creamer as the process according to the invention does not aim to change the milk protein content of the starting dairy product (skim milk) and cream is added to obtain the desired fat content. Such a ratio ensures that the dairy creamer presents the required consistency and flavour.

The obtained dairy creamer typically contains from about 13.5 to about 17 wt % of total solids.

The obtained dairy creamer typically contains from about 0.01 to about 0.6 wt % of minerals.

Typically, the mixing of cream and the diluted fraction is done with a metering pump which injects the diluted fraction into the cream line. Additionally, the cream and the diluted fraction can be mixed in typical fluid mixing operations used in dairy industry like high speed blenders or liquefiers.

### Steps h) to k)

The dairy creamer resulting from steps a) to g) as disclosed herein above is then processed as any regular dairy creamers.

Typically, the further processing steps do not comprise any fermentation step (for instance with addition of an acid or lactic ferments) nor any addition of lactase or any other enzymes. In an optional step, a stabilizing salt and/or a flavor may be are added to the dairy creamer.

The amount of the added stabilizing salt typically ranges from 0 to 2 wt % with respect to the weight of the final dairy creamer. Examples of suitable stabilizing salts include, but are not limited, to a salt (e.g. sodium or potassium salt) of citrate, a salt (e.g. sodium or potassium salt) of phosphate, a salt (e.g. sodium or potassium salt) of di- or poly-phosphate, and mixtures thereof.

Examples of suitable flavors include, but are not limited, to fruit flavors, baked foods flavors, confectionary flavors, vanilla flavors, caramel flavors, coffee flavors, chocolate flavors, and mixtures thereof.

The dairy creamer may then be heat treated. Heat-treatment may allow to extend the shelf-life of the dairy creamer from short (refrigerated product) to shelf stable. For instance, pasteurization and/or ultra-high temperature (UHT) procedures may be applied to dairy creamer.

Pasteurization may be performed at a temperature ranging from 72° C. to 138° C., preferably during 2 seconds to 30 minutes, in particular pasteurization may be performed at a temperature ranging from 72° C. to 90° C., preferably during 15 seconds to 20 seconds. Such a step and its conditions are well known to the one skilled in the art.

UHT procedures may be performed at a temperature ranging from 135 to 145° C., preferably for few seconds, notably from 1 to 10 seconds, preferably from 2 to 5 seconds.

The dairy creamer may be homogenized. Homogenization may ensure that the fat content is evenly distributed in the aqueous fraction of the dairy creamer. Homogenization may be performed in accordance with well-known procedures.

The dairy creamer is then packaged in any suitable package. The packaging technique used is not particularly limited as long as it preserves the integrity of the dairy creamer for the applicable shelf life of the dairy creamer. The package may be unit doses (e.g. containing about 15 mL of the dairy creamer) or cartons (e.g. containing from about 500 mL to about 1 L of the dairy creamer).

Typically, before packaging, the dairy creamer is cold to a temperature between about 4° C. and about 30° C. depending if the product is refrigerated or shelf stable. If the product is refrigerated, the dairy creamer will advantageously be cold to a temperature ranging from about 4° C. to about 10° C. If the product is shelf stable, the dairy creamer will advantageously be cold to a temperature ranging from about 10° C. to about 30° C.

Embodiments of the present invention will now be described by way of the following examples which are provided for illustrative purposes only, and not intended to limit the scope of the disclosure.

1. A process for producing a dairy creamer that has a fat content not lower than 10.5 wt % and a carbohydrate content equal to or lower than 3.3 wt %, comprising the steps of:
a) providing a volume of skim milk having a protein content ranging from 2.5 to 4.5 wt % and a carbohydrate content ranging from 4.5 to 5.5 wt %;
b) concentrating the skim milk by ultrafiltration and collecting the obtained protein-enriched retentate;
c) diluting the protein-enriched retentate with enough water to reach at least 80 vol % of the initial volume of skim milk to obtain a diluted fraction having a reduced carbohydrate content;
d) optionally repeating one or more times steps b) and c) on the diluted fraction resulting from step c) to further reduce the carbohydrate content of the diluted fraction;
e) concentrating the diluted fraction resulting from step c) or d) by ultrafiltration and collecting the obtained protein-enriched retentate;
f) diluting the protein-enriched retentate resulting from step e) with enough water to provide a diluted fraction having a protein content ranging from 2.5 to 4.5 wt %;
g) adding cream to the diluted fraction resulting from step f) to provide a dairy creamer that has a fat content not lower than 10.5% by weight;
h) optionally adding a stabilizing salt and/or a flavor to the dairy creamer;
i) heat treating the dairy creamer;
j) optionally homogenizing the dairy creamer; and
k) packaging the dairy creamer.

2. The process of claim 1 wherein the carbohydrate content of the dairy creamer ranges from 0 wt % to 3.0 wt %.

3. The process of claim 1 wherein the carbohydrate content of the dairy creamer ranges from 0 wt % to 0.5 wt %.

4. The process of claim 1 wherein the fat content of the dairy creamer ranges from 10.5 wt % to 18 wt %.

5. The process of claim 1 wherein the concentrating step b and/or e) is performed by ultrafiltration at a temperature ranging from 30 to 55° C. and at a pressure ranging from 0.5 to 10 bar.

6. The process of claim 1 wherein the concentrating step b and/or e) is performed with a concentration factor of 2 to 4.

7. The process of claim 1 wherein the diluted fraction obtained in step f) has a carbohydrate content ranging from 0 wt % to 3.0 wt %.

8. The process of claim 1 wherein the diluted fraction obtained in step f) has a carbohydrate content ranging from 0 wt % to 0.5 wt %.

9. The process of claim 1 wherein the diluted fraction obtained in step f) contains from 0 to 1.0 wt % of fat.

10. The process of claim 1 wherein the diluted fraction obtained in step f) contains from 0 to 0.10 wt % of fat.

11. The process of claim 1 wherein the diluted fraction obtained in step f) contains from 5 to 15 wt % of total solids.

12. The process of claim 1 wherein the cream has a fat content of at least 30 wt %.

13. The process of claim 1 wherein the cream has a fat content ranging from 30 wt % to 40 wt %.

14. The process of claim 1 wherein the stabilizing salt is selected from the group consisting of sodium or potassium salt of citrate, sodium or potassium salt of phosphate, sodium or potassium salt of di- or poly-phosphate, and combinations thereof.

15. The process of claim 1 wherein the heat treating step comprises performing pasteurization and/or ultra-high temperature (UHT) procedures.

16. A dairy creamer that has a fat content not lower than 10.5 wt % and a carbohydrate content equal to or lower than 0.10 wt % obtainable according to the process of claim 1.
